(19) United States
(12) Patent Application Publication
(10) Pub. No.: US 2026/0303202 A1
(43) Pub. Date: Oct. 1, 2026

(54) COMMUNICATION INTERVAL FREQUENCY AND DURATION TUNING FOR SATELLITE-BASED DIRECT TO CELLULAR COMMUNICATIONS

(71) Applicant: AT&T Intellectual Property I, L.P., Atlanta, GA (US)

(72) Inventors: Jianlei Zhang, Allen, TX (US); Yunpeng Li, Austin, TX (US); Bo Gu, Allen, TX (US)

(21) Appl. No.: 19/097,757

(22) Filed: Apr. 1, 2025

(51) Int. Cl. H04B 7/185; H04W 28/02; H04W 84/06

(52) U.S. Cl. CPC H04B 7/18519; H04B 7/18539; H04B 7/18571; H04W 28/0268; H04W 84/06

(57) ABSTRACT

A processing system including at least one processor of a communication satellite may obtain a battery level indication of a battery level of the communication satellite, determine at least one sunlight timing factor associated with an exposure of the communication satellite to sunlight, and select at least a first communication interval frequency and at least a first communication duration within at least a first communication interval based upon the battery level and the at least one sunlight timing factor. The processing system may then process first data via the communication satellite in accordance with the at least the first communication interval frequency and the at least the first communication duration within the at least the first communication interval.

The present disclosure relates generally to satellite access for cellular networks, and more particularly to methods, non-transitory computer-readable media, and apparatuses for selecting for a communication satellite at least a first communication interval frequency and at least a first communication duration within the at least the first communication interval based upon a battery level indicator and at least one sunlight timing factor.

### BACKGROUND

Modern society may increasingly expect continuous network connectivity at any time of the day and day of the week. In many cases, a loss of connectivity may be considered an emergency. For example, first responders, governmental entities, medical facilities, home medical devices, and others may rely on consistent connectivity in order to function. In addition, small cells and wireless access points are increasingly prevalent. However, wireless access points and small cells may still assume access is available to a wired infrastructure capable of supporting high data rates, which may still remain infeasible in many areas of the world.

### SUMMARY

In one example, the present disclosure discloses a method, computer-readable medium, and apparatus for selecting for a communication satellite at least a first communication interval frequency and at least a first communication duration within the at least the first communication interval based upon a battery level indicator and at least one sunlight timing factor. For example, a processing system including at least one processor of a communication satellite may obtain a battery level indication of a battery level of the communication satellite, determine at least one sunlight timing factor associated with an exposure of the communication satellite to sunlight, and select at least a first communication interval frequency and at least a first communication duration within at least a first communication interval based upon the battery level and the at least one sunlight timing factor. The processing system may then process first data via the communication satellite in accordance with the at least the first communication interval frequency and the at least the first communication duration within the at least the first communication interval.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates examples for both receiving and transmitting for a satellite with tunable communication intervals and tunable communication duration within each communication interval;

FIG. 3 illustrates a flowchart of an example method for selecting for a communication satellite at least a first communication interval frequency and at least a first communication duration within the at least the first communication interval based upon a battery level indicator and at least one sunlight timing factor; and

FIG. 4 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for selecting for a communication satellite at least a first communication interval frequency and at least a first communication duration within the at least the first communication interval based upon a battery level indicator and at least one sunlight timing factor. In particular, satellite access has become an essential component of user connectivity, especially in remote areas. For instance, a non-terrestrial network (NTN) (e.g., a satellite access network (SAN)) can extend cellular coverage to areas where a terrestrial cellular network is not available or not economically viable. In addition, during natural disasters, satellite connectivity may comprise an important backup option to provide connectivity where terrestrial cellular infrastructure has been damaged. Examples of the present disclosure are particularly suited for improving user experience for cellular endpoint devices in remote or disaster-prone areas.

To further illustrate, examples of the present disclosure dynamically control the bandwidth allocation for a satellite (e.g., a communication satellite) serving multiple endpoint devices. For instance, examples of the present disclosure may determine real-time data demands and adjust the bandwidth allocation to reduce redundant energy consumption, thereby conserving power and extending satellite battery life. In particular, examples of the present disclosure feature a sequence of communication intervals between a communication satellite and endpoint devices, where each communication interval includes heartbeat signaling and a data communication block (e.g., having a duration/bandwidth). The data communication duration may be controlled dynamically as described herein. In addition, the present disclosure may control the interval duration (and hence the period/frequency of the communication intervals). Thus, within each interval, the system can control (1) the length/duration of the sending and/or receiving signals following each heartbeat and (2) the timing between heartbeats. This fine-grained control allows for more precise management of power consumption and bandwidth usage.

In one example, the present disclosure may comprise a dynamic bandwidth and power management system (DBPMS) that provides fine-grained control over the length of communication intervals and the duration/length/data volume of data sent or received. This precise control enhances the synchronization of data packets, thereby reducing latency and jitter, and improving the overall quality of service. The optimized signal intervals also contribute to significant reductions in power consumption. In one example, the present disclosure may incorporate artificial intelligence (AI) and/or machine learning (ML) models for predictive analysis and decision-making. For instance, one or more machine learning models may analyze historical data to forecast future bandwidth demands, enabling proactive adjustments in interval period/duration and/or data communication duration within each interval. The self-learning capabilities allow a communication satellite to continuously improve performance by adapting to new data, ensuring long-term efficiency and effectiveness. This AI/ML-based dynamic bandwidth adjustment and precise heartbeat interval control provides a highly efficient system with substantial battery and power conservation for a communication satellite, as well as extended battery life for connected devices, improved network performance, and scalability

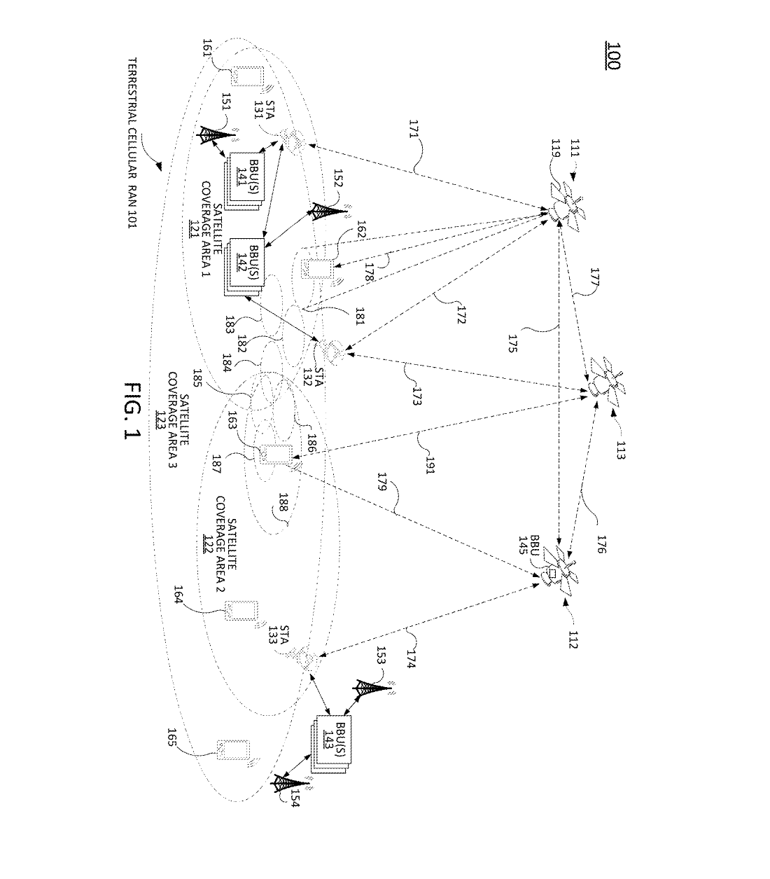

Technical advantages of the present disclosure may include but are not limited to: extended battery life (e.g., by reducing power consumption through efficient bandwidth management, a communication satellite’s battery life is extended), improved efficiency (e.g., examples of the present disclosure help ensure that power is used only when necessary, leading to more efficient satellite operations), enhanced performance (e.g., optimized bandwidth allocation improves the overall performance such as maximized average throughput, reductions in packet loss and/or call drop rates, or other indicators of quality of service (QoS), etc.), increased scalability (e.g., examples of the present disclosure can scale to accommodate varying numbers of endpoint devices sending and/or receiving data and which may have different types of data demand), and extended satellite lifespan and reduced maintenance (e.g., due at least in part to reduced power consumption, which may also lead to significant cost savings in satellite operations and maintenance). These and other aspects of the present disclosure are discussed in greater detail below in connection with the examples of FIGS. 1-4.

FIG. 1 illustrates an example network, or system 100 in which examples of the present disclosure may operate. In one example, the system 100 includes a terrestrial cellular radio access network (RAN) 101 (e.g., a 5G RAN, a 5G/4G/Long Term Evolution (LTE) hybrid RAN, an evolved Universal Terrestrial Radio Access Network (eUTRAN), or the like). In one example, the terrestrial cellular radio access network (RAN) 101 may comprise a cloud RAN. For instance, a cloud RAN is part of the 3rdeneration Partnership Project (3GPP) 5G specifications for mobile networks. As part of the progression of mobile/cellular networks towards 5G, a cloud RAN may be coupled to a 5G core network and/or to an Evolved Packet Core (EPC) network until new cellular core networks are deployed in accordance with 5G specifications.

To further illustrate, the terrestrial cellular RAN 101 may include a plurality of cell sites 151-154, which may each comprise a radio unit (RU) or remote radio head (RRH) of a cellular base station, e.g., a gNodeB, or gNB. In addition, the terrestrial cellular RAN 101 may include a plurality of baseband units (BBUs) 141-143, which may be associated with one or more cellular base stations (e.g., gNBs). For instance, the BBUs 141-143 may represent one or more distributed units (DUs) and/or one or more centralized units (CUs) assigned to one or more cellular base stations and/or cell sites. It should be noted that in accordance with an Open-Radio Access Network (ORAN) architecture, CUs and DUs may be disaggregated and deployed on computing resources at different physical locations. However, for ease of illustration, these components are represented collectively as BBUs (e.g., BBUs 141-143, illustrated as BBU pools).

In particular, a BBU pool may be located at distances as far as 20-80 kilometers or more away from the antennas/remote radio heads of cell sites that are serviced by the BBU pool. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less. Although cloud RAN infrastructure may include distributed RRHs and centralized baseband units, a heterogeneous network may include cell sites where RRH and BBU components remain co-located at the cell site. For instance, a cell site may include RRH and BBU components and may thus comprise a self-contained “base station.”

FIG. 1 also illustrates various endpoint devices 161-165, e.g., user equipment (UEs) such as cellular endpoint devices. For instance, endpoint devices 161-165 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing devices (broadly, “an endpoint device”). In one example, endpoint devices 161-165 may each be equipped with one or more directional antennas, or antenna arrays (e.g., having a half-power azimuthal beamwidth of 120 degrees or less, 90 degrees or less, 60 degrees or less, etc.), e.g., multiple input-multiple output (MIMO) antenna(s) to receive multi-path and/or spatial diversity signals. Some or all of the endpoint devices 161-165 may also include a gyroscope and compass to determine orientation(s), a global positioning system (GPS) receiver for determining a location (e.g., in latitude and longitude, or the like), and so forth. In one example, some or all of the endpoint devices 161-165 may include a built-in/embedded barometer from which measurements may be taken and from which an altitude or elevation of the respective endpoint device may be determined. In one example, some or all of the endpoint devices 161-165 may also be configured to determine location/position from near field communication (NFC) technologies, such as Wi-Fi direct and/or other Institute of Electrical and Electronics Engineers (IEEE) 802.11 communications or sensing (e.g., in relation to beacons or reference points in an environment), IEEE 802.15 based communications or sensing (e.g., “Bluetooth™,” “ZigBee™,” etc.), and so forth.

As further illustrated in FIG. 1, the system 100 includes satellites 111-113 (e.g., communication satellites or non-terrestrial network (NTN) nodes), each having a respective satellite coverage areas 1-3 (121-123). The satellites 111-113 together with ground stations (STA) 131-133 may comprise a non-terrestrial network (NTN), e.g., a satellite network. Notably, 3GPP standards (e.g., release 17 and beyond) expand the concept of cellular services over non-terrestrial networks in which satellites or other NTN nodes may include 3GPP new radio (NR) compliant technologies. For instance, in the example of FIG. 1, satellites 111-113 may each include remote radio heads (RRHs) and/or radio units (RUs), e.g., according to O-RAN definitions. In some examples, satellites or other NTN nodes may also include BBUs, DUs, and/or CUs. For instance, in FIG. 1, satellite 112 may include a BBU 145.

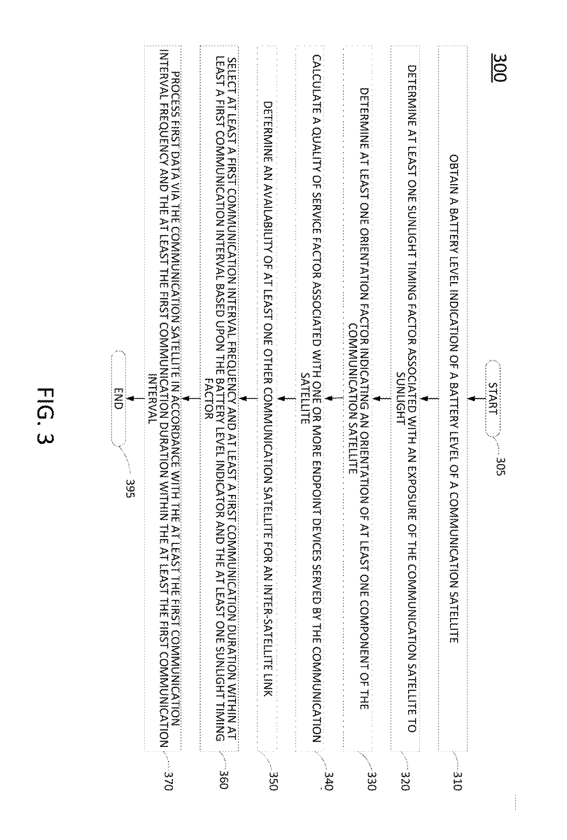

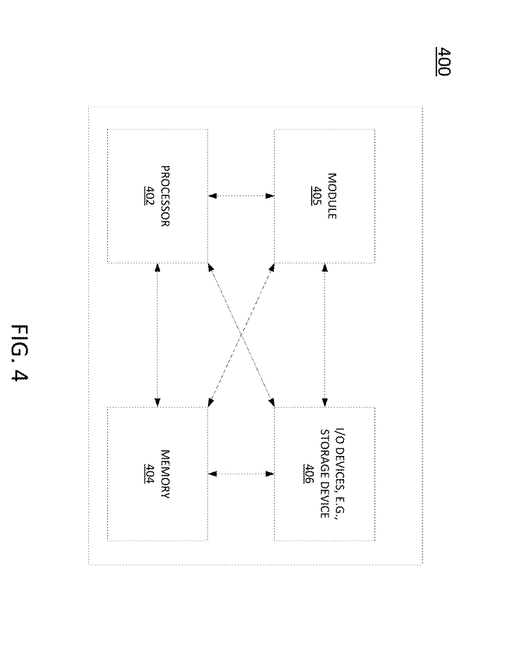

In one example, each of satellites 111-113 may comprise all or a portion of a computing system, such as computing system 400 depicted in FIG. 4, and may be configured to perform one or more steps, functions, and/or operations for selecting for a communication satellite at least a first communication interval frequency and at least a first communication duration within the at least the first communication interval based upon a battery level indicator and at least one sunlight timing factor, such as illustrated and described in connection with the example method 300 of FIG. 3. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In various examples, one or more NTN nodes may dynamically map to one or more baseband units. For instance, as illustrated in FIG. 1, satellite 111 may establish feeder links with either of ground stations 131 or 132, via which satellite 111 (e.g., a radio unit/RRH thereof) may be associated with one of the BBUs 141 or 142. In addition, satellite 111 may maintain an inter-satellite link (ISL) 175 with satellite 112 by which it may be associated with BBU 145. Thus, RRHs deployed to NTN nodes (e.g., satellites 111-113) may be paired with different BBUs to complete respective disaggregated base stations over a hybrid cellular/NTN network (and similarly for satellite 112 and/or satellite 113).

Each of the satellites 111-113 may have one or more feeder links 171-174) to one or more ground stations (e.g., also referred to as satellite gateways or satellite access nodes), e.g., ground stations (STAs) 131-133. In addition, the satellites 111-113 may have inter-satellite links (ISLs) 175-177 as further illustrated in FIG. 1. In accordance with the present disclosure, satellites 111-113 may each provide cellular network connectivity services to endpoint devices in connection with terrestrial cellular RAN 101. For instance, satellite 111 may serve endpoint device 162 via beam 181. The connection for endpoint device 162 to satellite 111 may be referred to as a “service link” (e.g., service link 178). Notably, satellite 111 may be capable of providing beam coverage anywhere within satellite coverage area 1 (121). However, to support performance (e.g., data rates, throughput, latency, etc.) that is the same or as close as possible to terrestrial cellular service, more focused directional beams may customarily be used (e.g., such as illustrated by beams 181-184). For ease of illustration, only four beams are shown for satellite coverage area 1 (121), where it should be understood that additional beams of a same or similar nature may be provided by satellite 111 in other portions of satellite coverage area 1 (121). Similarly, satellite 112 may offer various beams, such as beams 185-187 within satellite coverage area 2 (122). For example, endpoint device 163 may have a service link 179 with satellite 112 established over beam 187. It should be noted that some beams near the edges of satellite coverage areas 1 and 2 (121 and 122) may be overlapping or partially overlapping (e.g., beams 184, 185, and 186). Thus, an endpoint device in such location(s) may have a choice of different beams.

Satellite 113 may also offer a beam 188 which may overlap with beams 185-187. In particular, satellite 113 may comprise a high earth orbit (HEO) satellite, such as a geostationary satellite which may be at a substantially higher altitude than satellites 111 and 112. For instance, satellites 111 and 112 may comprise low earth orbit (LEO) or medium earth orbit (MEO) satellites. Accordingly, the satellite coverage area 3 (123) may be substantially larger than the satellite coverage areas 1 and 2 (121 and 122). It should be understood that endpoint devices 161-165 or other devices may similarly obtain service links with any of the satellites 111-113 for which the respective endpoint devices are within an associated one of the satellite coverage areas 1-3 (121-123), and that the corresponding ones of the satellites 111-113 may provide directional beams to support the service links for one or a plurality of such endpoint devices. Similarly, any of the endpoint devices 161-165 may attach to terrestrial cellular network 101 via any of the cell sites 151-154 that is/are within communication range. For ease of illustration, the communication ranges(s) of cell sites 151-154, e.g., cell footprints, and potential links between endpoint devices 161-165 and cell sites 151-154 are omitted from FIG. 1.

It should be noted that FIG. 1 illustrates two architecture modes for extending cellular services across NTN air interfaces to endpoint devices. In particular, in a non-regenerative mode, also referred to as a transparent mode, the uplink may involve a satellite radio unit (RU) or RRH receiving uplink data traffic from endpoint devices via service links, and forwarding the data traffic to a ground station via a feeder link, where the ground station may further pass the data traffic to a baseband unit. For instance, in one example, satellite 111 may receive data traffic from endpoint device 162 via service link 178, and may retransmit the data traffic via feeder link 171 to ground station 131. In turn, ground station 131 may pass the data traffic to one of the BBUs 141 or 142. In another example, satellite 111 may retransmit the data traffic via feeder link 172 to ground station 132, where ground station 132 may pass the data traffic to one of the BBUs 142. The uplink may follow a similar pattern in reverse. For example, uplink data for endpoint device 162 may be received at one of the BBUs 141 or 142, e.g., from a cellular core network element (such as a user plane function (UPF), etc.) and may be forwarded to ground station 131 or 132 for transmission to satellite 111 via feeder link 171 or 172. In either case, the satellite 111 may retransmit the data traffic via service link 178 over beam 181 to endpoint device 162.

In a regenerative model, the entire RAN infrastructure (or at least an RU and DU) may be deployed to a NTN node. For instance, FIG. 1 illustrates that satellite 112 may include a baseband unit 145 (e.g., in addition to an RU/RRH (not shown)). In this case, BBU 145 may establish links/interfaces to cellular core network components (e.g., a UPF, an access management function (AMF), etc.) via ground station 133. While the data flow for serving endpoint device 163 may be similar to the transparent mode, the demarcation points for different RAN and cellular core links/interfaces are different. To further illustrate, satellite 112 may receive uplink data traffic from endpoint device 163 via service link 179. BBU 145 may process the data traffic and may retransmit the data traffic via feeder link 174 to ground station 133. In turn, ground station 133 may pass the data traffic to a cellular core network element/network function (e.g., a UPF, or for management traffic an AMF, etc.). Similarly, ground station 133 may receive uplink data traffic, e.g., from a cellular core network element, and may transmit the data traffic to satellite 112 (e.g., to BBU 145). BBU 145 may process the data traffic and may retransmit the data traffic to endpoint device 163 via service link 179.

It should be noted that BBU 145 may process data traffic not only for endpoint device 163 and/or other devices having service links to satellite 112, but also for other endpoint devices having service links via other satellites. For instance, in one example, satellite 111 may provide cellular network access to endpoint device 162, e.g., via service link 178. However, satellite 111 may associate itself with BBU 145 rather than a terrestrial-based BBU. In this case, uplink data traffic for endpoint device 162 may be received via service link 178 and retransmitted via inter-satellite link (ISL) 175 to BBU 145. BBU 145 may process the data traffic and in one example may retransmit the data traffic via feeder link 174 to ground station 133 (e.g., for onward forwarding to a cellular core network). Uplink data traffic for the endpoint device(s) 162 may follow a similar path in reverse. The use of regenerative mode and NTN-based BBUs may enable some satellites to continue to provide usable service links to endpoint devices even when a ground station is not visible or within communication range of such satellite, e.g., if the satellite is still able to maintain an ISL with another satellite. In addition, an NTN-based BBU, such as BBU 145, may also enable routing of data traffic between certain endpoint devices without the need to enter or traverse the cellular core network. This can be particularly advantageous where the routing of data traffic over feeder links can be avoided, e.g., resulting in substantial latency savings, etc. For instance, if endpoint device 163 is communicating with endpoint device 164 (e.g., having its own service link to satellite 112 (not shown)), BBU 145 may hairpin the communication through satellite 112 without relay to ground station 133. It should be noted that this type of situation may occur frequently where users may be travelling in a group in the wilderness or traveling on a ship where satellite connectivity may be the only option or the most viable option to maintain connectivity to a cellular network, and where the users may often use their endpoint devices to maintain in voice and text contact when out of direct face-to-face communication range (such as at opposite ends of a ship, when a mile or more apart on a trail, etc.).

Examples of the present disclosure may provide for continuous or nearly continuous cellular network connectivity via a NTN network for wireless access. However, satellite communication was not originally designed for high-speed/high-bandwidth connections for cellular endpoint devices. In addition, satellite communication is generally used when there is no terrestrial cellular coverage at all. In one example, low-band, narrow bandwidth channels may be used for endpoint devices in idle mode, e.g., for paging, endpoint device tracking, session keep alive, etc. In one example, endpoint devices may have temporary spikes in demand for data over satellite and may be provided higher spectrum band and/or wider bandwidth channels, but may be pushed back to low-band, narrow channel, and/or wide coverage beams when temporary high data needs have passed, e.g., switching back to idle mode. In one example, higher orbit satellites, such as those in HEO and/or geostationary orbits, may use lower band beams and provide wider coverage, while satellites with lower orbits, such as MEO or LEO satellites, may be capable of maintaining data connections at higher frequency bands and/or with wider channel bandwidths, but with reduced coverage. In one example, higher orbit satellites may provide service links for control signaling and lower orbit satellites may provide service links for higher data needs for temporary communications, e.g., to send and/or receive a text message, to make a short voice call, etc. For instance, in one example, an endpoint device may be paged for a voice call via a control channel over a service link with a first satellite/satellite beam and may then be provided with a secondary service link via a different satellite/satellite beam with a higher frequency and/or channel width to receive and send voice data.

To further illustrate, in the example of FIG. 1, satellite 113 may comprise a HEO and/or geostationary satellite that may provide idle mode signaling for endpoint device 163 via a service link 191 over beam 188. In one example, the service link 191 may be allocated a narrow bandwidth channel (e.g., 5 MHz or less, 10 MHz or less, or the like) within a low band (e.g., 900 MHz or less, 1100 MHz or less, or the like). Notably, service link 191 may be sufficient to enable control channel monitoring by endpoint device 163, and for paging by satellite 113 (e.g., the RRH/RU thereof, controlled by a BBU, such as one of the BBUs 143 or BBU 145, etc.). However, the narrow bandwidth channel for service link 191 may be insufficient when a user of endpoint device 163 may seek to initiate a voice call. In this case, in one example, endpoint device 163 may identify available satellites and/or beams, and may select a beam from among the available beams that may support the desired voice call. For instance, in the present example, it may be possible for endpoint device 163 to establish service links with satellite 113, e.g., via beam 188 or with satellite 112, e.g., via beam 187. In this case, endpoint device 163 already has a service link 191 established with satellite 113 via beam 188, which may be insufficient to support the voice call. Accordingly, in such an example, endpoint device 163 may elect to establish service link 179 with satellite 112 over beam 187. For instance, beam 187 may offer higher bandwidth channels, which may be in a higher band than a band associated with beam 188 (e.g., beam 187 may be in the 1.8 GHz or above range, within a C-band (such as 3.7-3.98 GHz), or the like, and may provide channels with channel widths of 20 MHz or greater). Endpoint device 163 may then engage in voice communications over service link 179. For uplink voice data, satellite 112 may process the voice data internally at BBU 145 and may retransmit the voice data to ground station 133 over feeder link 174 for onward transmission to a cellular core network element (e.g., a UPF, etc.) or may act as a repeater by retransmitting the voice data to ground station 133 for forwarding to one of the BBU(s) 143. Downlink voice data may similarly follow one of these paths/processes in reverse.

It should be noted that in one example, if a voice communication is with another endpoint device that is attached to the terrestrial cellular RAN 101 via another satellite connection, such as endpoint device 162, and if satellite 112 is using its own internal BBU 145, the BBU 145 may determine to route the voice call via ISL 175 and satellite 112, e.g., without using feeder link 174 and without traversal of a cellular core network. In one example, service link 191 may be maintained for endpoint device 163, and may continue to be used for control plane signaling while higher data rate service for the voice call may proceed via service link 179. In another example, service link 191 may be released, and all cellular communications for endpoint device 163 may utilize service link 179. In one example, after a need for higher data rates has passed, the endpoint device 163 may then seek to switch back to a service link over a beam providing low band, narrow bandwidth channel(s) for idle mode (such as re-establishing service link 191 via beam 188, via a different beam of satellite 113, or via a beam of a different NTN node). Although the foregoing describes a data communication demand for a voice call, in other examples, higher data demands may similarly relate to engaging in text message communications (e.g., Short Message Service (SMS) messages, Multimedia Messaging Service (MMS) messages, Rich Communications Service (RCS) messages, over-the-top (OTT) messaging application messages, and so forth).

It should be noted that the foregoing is just one example of satellite/beam selection in which a beam of a HEO satellite with a lowband, narrow bandwidth channel may be used for idle mode and where a beam of a LEO satellite with higher band, wider bandwidth channel may be used for higher data demand. However, it should be understood that the present disclosure is not limited to specific bands, bandwidth channels, satellite deployment types, cellular RAN fronthaul architectures, and so forth. For instance, in another example, endpoint device 163 may be at a location at the intersection of beams 184, 185, and 186, and may potentially establish cellular network connectivity via any of these beams. In addition, for illustrative purposes, it may be the case that satellite 113 is not visible to endpoint device 163 or is otherwise unavailable. In this regard, in one example, endpoint device 163 may include selection logic to evaluate and select a best beam from among a plurality of available beams of one or more NTN nodes to establish a service link, and to maintain NTN-based attachment to the terrestrial cellular RAN 101.

For example, the endpoint device 163 may make a determination of a best beam based upon channel bandwidth information for each of the plurality of NTN nodes and/or particular beams thereof. For instance, if the endpoint device 163 is in idle mode, a narrower bandwidth channel may be preferred (which may generally be associated with a lower frequency band). On the other hand, if endpoint device 163 is active and has a current communication demand, e.g., for text, voice, email, or another user data service, the endpoint device 163 may search for a beam with wider bandwidth, e.g., which may support higher data rates and which may generally be associated with higher frequency bands. In various examples, the endpoint device 163 may further consider flightpath information for one or more of the NTN nodes, load information for one or more of the NTN nodes (or for one or more beams of the one or more NTN nodes), signal strength information for one or more beams of the one or more NTN nodes, and so forth. In addition, endpoint device 163 may predict future locations and may seek to pre-establish a new service link in anticipation of being at a future location at a future time, and in advance of releasing an existing/current service link.

Alternatively, or in addition, in one example, endpoint device 163 may further consider a data communication demand for the endpoint device 163, which may be either to or from the endpoint device 163. For instance, for inbound communications, the endpoint device 163 may be paged, e.g., in idle mode, indicating the data volume or anticipated data volume. For instance, for a higher data demand, the endpoint device 163 may look for higher bandwidth channel (which may generally be in a higher frequency band, and which may be provided by a LEO satellite versus a geostationary HEO satellite, which may not be able to offer higher frequency signals, e.g., due to attenuation over substantially greater distances). For a lower data demand, the endpoint device may look for the lowest bandwidth channel that can just support the data demand, e.g., to upload or download content within a “reasonable” time, which may be an adjustable parameter that may be set based on use preferences and/or an network operator preference. In still another example, endpoint device 163 may alternatively or additionally consider a battery charge condition of the endpoint device 163. For example, the endpoint device 163 may determine that it is too costly to connect to a LEO satellite, such as satellite 112, which may only be temporarily in view, even if it would enable endpoint device 163 to consume less battery charge to connect as compared to other NTN nodes if the satellite 112 were available long term. For example, the power consumption to handover twice could exceed the savings, where it may be better to stay on a low-band narrow-bandwidth connection to a higher satellite, such as satellite 113.

In addition, in accordance with the present disclosure, satellites may control their bandwidth utilizations, and hence power and battery consumption, based upon current battery levels and availability of sunlight for recharging batteries and/or powering electronic components. For instance, satellite 111 may determine a battery level, or charge level, of one or more batteries of the satellite 111 as well as a sunlight timing factor associated with an exposure of the satellite 111 to sunlight. For instance, the satellite 111 may include one or more solar panels, or array(s), such as solar panel 119, that may generate electrical current from incident sunlight. To further illustrate, an orbit of satellite 111 may cause the satellite 111 to alternatively be exposed to sunlight via a direct line to the Sun and shielded from sunlight by the Earth. In this regard, as referred to herein, a sunlight timing factor may include: a duration of time after which satellite 111 will again be exposed to sunlight (when currently shielded from the Sun), a time when the satellite 111 will again be exposed to sunlight (e.g., in hour, minute, and second per a reference terrestrial time zone, such as Greenwich Mean Time (GMT), or the like), a duration of time which the satellite 111 will be exposed to sunlight (e.g., when currently exposed to sunlight, this could be a duration of time from the present until the satellite is shielded from the Sun by the Earth; when not currently exposed to the Sun, this could be the duration of time over which a next cycle exposure to the Sun may last), etc. Alternatively, or in addition, a sunlight timing factor may include a duration of time that the satellite 111 will remain in darkness/shielded from the Sun, a time at which the satellite 111 will stop being exposed to sunlight and/or when the satellite 111 may again be shielded from the Sun, and so forth. It should be noted that satellite 111 may use more than one such sunlight timing factor to control its bandwidth utilization. For instance, when satellite 111 is currently shielded from the Sun, the bandwidth utilization may be selected based upon a battery level, a duration of time until the satellite 111 is next exposed to the Sun, and a duration of time over which the satellite 111 will then be exposed to the Sun until again being shielded from the Sun. Satellite 111 may then select/compute a communication interval frequency and at least a first communication duration within at least a first communication interval based upon the battery level indicator and the at least one sunlight timing factor.

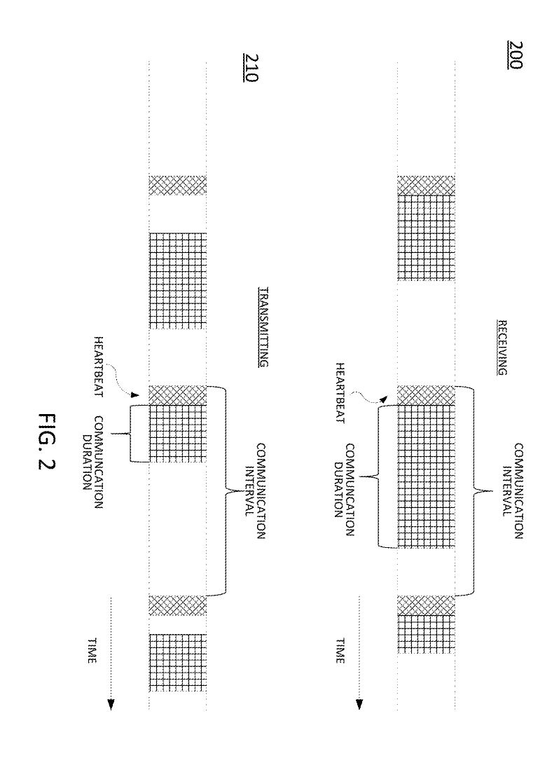

In this regard, FIG. 2 illustrates examples for both receiving (200) and transmitting (210) for a satellite, such as satellite 111. For instance, in the receiving example 200, satellite 111 may select a communication interval (and/or a frequency/period between heartbeat signals) as well as communication duration within each communication interval. It should also be noted that the heartbeat plus communication duration may be less than the entirety of the communication interval. The transmitting example 210 further shows that the beginning of the data transmission within the communication interval may also be controlled/selected. For instance, satellite 111 may select a communication interval of X ms, with a communication duration of Y ms that starts Z ms after the heartbeat (where Y and Z are both less than X, and where the sum of Y, Z, and the heartbeat duration are also less than X). Thus, for both transmission and reception satellite 111 may control the tunable parameters: (1) the interval length (and/or frequency/period), (2) the communication duration within each interval, and optionally (3) a delay or gap between a heartbeat and data transmission/reception within each interval.

In one example, satellite 111 may change one or more of these tunable parameters for each interval or on another basis, e.g., periodically, such as every 10 intervals, every 20 intervals, every 50 intervals, or the like. In one example, satellite 111 may adjust these parameters on a per-beam basis or across all beams (e.g., if using distinct beams). It should be noted that uplink scheduling by satellite 111 may allocate slots to endpoint devices within the communication duration within each interval, while avoiding assignment of slots in any remaining portions of the interval that are not part of the communication duration/communication window. Thus, from the perspective of the endpoint devices, there is no change to uplink scheduling procedures (and similarly with respect to the downlink). It should be noted that the same or similar processes/functionality may be implemented by satellites 112 and 113. In addition, in one example, such functionality may be implemented within a satellite baseband unit, such as BBU 145.

Notably, prior approaches to satellite communication may utilize the entirety of the communication interval, e.g., with transmit and/or receive power utilized across the whole interval. In contrast, a satellite according to the present disclosure may select a communication duration that is less than the entirety of the communication interval remaining after the heartbeat. In particular, this may provide a significant savings in power consumption and/or battery charge consumption over time. In addition, in accordance with the present disclosure, a satellite may select the communication interval (and/or the frequency or period of a sequence of communication intervals), which may provide further power/battery consumption savings in conjunction with the tuning of the communication durations with the communication intervals. For instance, regardless of a level of demand for NTN-based cellular access via a satellite, the satellite may have a limit for a sustainable rate of power consumption, e.g., without running out of remaining battery charge before solar panels are able to recharge one or more batteries, or without running the battery charge so low that the one or more batteries cannot be recharged back to a target level during a current or a next window of sunlight, and so forth.

In one example, a satellite, such as satellite 111, may also determine one or more additional factors upon which the satellite 111 may compute a selection of tunable parameters (e.g., (1) the interval length (and/or frequency/period), (2) the communication duration within each interval, and optionally (3) a delay or gap between a heartbeat and data transmission/reception within each interval). For instance, in one example, satellite 111 may further determine an orientation factor, which may indicate the relative orientation of satellite 111 and/or the one or more solar panels (such as solar panel 119) thereof with respect to the Sun. For instance, the orientation may affect how efficient the solar panel(s) may be in converting sunlight to electric current, which may be quantified in the orientation factor. For example, the orientation factor may be an angle of incidence between a direct line from the Sun (or a center of the Sun) to the surface plane of solar panel 119 (or a fixed reference plane relative to a length of satellite 111, a width of satellite 111, a central axis of satellite 111, or the like). In one example, the orientation factor may be used to compute the one or more sunlight timing factors or to weight the one or more sunlight timing factors. For instance, the satellite 111 may estimate how much a battery may be recharged given a time of exposure to sunlight modified by the orientation factor (e.g., which may be proportional to or otherwise a function of the angle of incidence of the sunlight across the surface of a solar panel/solar array). Still other factors may include endpoint device quality of experience (QoE) (or quality of service (QoS)) demand in terms of service type, e.g., video download, versus other services, data rate, etc.

In one example, a type of service may be part of the QoE factor or may be a separate factor to consider in conjunction with the QoE factor. For instance, some applications can better tolerate a lower data rate, while for others, the QoE will drop more significantly even with a smaller reduction in the data rate. Thus, for instance, satellite 111 may prioritize communication for certain types of services over other services, e.g., allocating more uplink and/or downlink slots to certain types of services and/or endpoint devices using the respective types of services. In addition, satellite 111 may seek to optimize QoE across endpoint devices (given the distribution of services in use) and may allocate as much bandwidth (e.g., communication durations across a sequence of intervals) as satellite 111 determines is sustainable without draining the battery charge of satellite 111. In this regard, satellite 111 may also set the interval/period itself in connection with these considerations. Similarly, another factor may be device type(s) which may be a stand-alone factor or which may be accounted for in the QoS factor (e.g., weighting based on device type or the like).

Other factors may be the total available bandwidth of satellite 111, communication load information of satellite 111, such as a number of attached endpoint devices having service links with the satellite, an average data volume, an average uplink data volume, and average downlink data volume, and/or the like (e.g., in a recent time period and/or over one or more recent time periods, e.g., 5 minute moving averages over the last 4 hours, etc.). In one example, a factor may be an availability of other satellites within communication range of satellite 111 and/or a number of endpoint devices being served by satellite 111. For instance, this factor may be relevant to the possibility of indirect backhaul and/or for offloading of endpoint devices to such other satellite(s). In still another example, a factor may include a weather factor. For instance, cloudy weather can impact signal strength and/or packet error. Thus, the detected presence (or lack thereof) of cloudy weather (or rainy, smoky, foggy, or similar weather) may comprise an input factor that is used by satellite 111 to determine the tunable parameters. To further illustrate, if cloudy weather is detected by satellite 111 (e.g., via satellite-based sensing and/or via ground-based or other external sensing that is provided to satellite 111), satellite 111 may compute that power consumption may increase per unit of data transmitted and/or received as compared to if conditions were relatively clear between the satellite 111 and the endpoint devices being served (and/or between satellite 111 and ground station 131 and/or ground station 132). Accordingly, satellite 111 may shorten the communication duration within one or more communication intervals to reduce the power consumption.

In one example, the selection/computation of tunable parameters (e.g., (1) the interval length (and/or frequency/period), (2) the communication duration within each interval, and optionally (3) a delay or gap between a heartbeat and data transmission/reception within each interval) may be performed by a satellite via a machine learning model (MLM) implemented by the satellite. To further illustrate, a satellite, such as one of the satellites 111-113, may comprise a machine learning model (MLM) that is trained to generate/output an interval length (and/or frequency/period) and communication duration (and in one example further including the delay) in response to a set of inputs (an input vector) comprising the battery level indication of the satellite and at least one sunlight timing factor of the satellite as discussed above. In one example, the input vector may further include one or more additional factors such as noted above, e.g., QoE, device type(s), weather, availability of other satellites, time of day, day of the week, month or season or the like. For instance, such a MLM may be trained to account for historic trends, but at any given time, an optimal parameter selection may be more likely to be achieved when particularly taking into account the most recent/most up to date information on current numbers of endpoint devices served, the service types in use, the current weather, etc. In one example, the MLM may be retrained periodically or otherwise, or may be updated on an ongoing basis, e.g., via reinforcement learning (RL) or the like, to keep the MLM current. In addition, insofar as non-stationary NTN nodes have orbits that are fixed/predictable, time, date, and/or other temporal factors may also be embedded within the training of the MLM. Thus, from any or all of these input factors, or the like, and based upon model training using historic data patterns, a trained MLM of one of the satellites 111-113 may thus generate an output comprising a set of parameters for bandwidth and/or power management (e.g., interval length (and/or frequency/period) and communication duration (and in one example further including the delay).

In one example, training data may comprise labeled records of parameter selection/assignments (e.g., the values of: (1) interval duration, (2) communication duration within one or more intervals, and optionally (3) an offset duration). For instance, in one example, the labels may indicate whether the assignment was “successful” or “unsuccessful,” and/or a degree or measure of success. To illustrate, if satellite 111 runs out of battery charge while shielded from the sun, a set of parameter used in a time preceding the depletion may be labeled as unsuccessful. Likewise, if the satellite 111 fails to meet QoE thresholds for one or more endpoint devices, services, etc., then the parameters may be labeled with a value between 0 and 1, 1 to 100, or the like indicating the average extent to which QoE thresholds for endpoint devices served by satellite 111 were or were not met. For instance, the QoE thresholds may be for each service type engaged by the respective endpoint devices, such as voice calls, streaming video, video conferencing, web browsing, text messaging, etc.

Thus, a satellite operator may set one or more thresholds and/or may use one or more formulas to determine whether an assignment was successful or not. For instance, if a call drop rate, a call block rate, latency metrics, throughput metrics, or the like fail to meet one or more performance thresholds/benchmarks, the assignment may be labeled as unsuccessful (otherwise a label of “successful” may be applied). In still another example, the labels may be on a scale, such as 1-5, 1-10, 0-10, 0-100, etc. indicating a level or percentage of success (or lack thereof). For instance, a formula may be based on one or more of the foregoing factors (e.g., call drop rate, call block rate, latency, throughput, etc.), where an output “score” or value may indicate the relative level of success. Thus, the MLM may be trained to optimize the QoE and/or other metric(s) across endpoint devices being served, while ensuring that the satellite 111 does not run out of available battery charge at any time. Alternatively, or in addition, the MLM may be trained to optimize the QoE and/or other metric(s) while minimizing power consumption at the satellite 111.

Thus, labels such as described above may be used in conjunction with corresponding records data regarding the parameter selections/assignments as training data for MLM training. In one example, the training data may be specific to the satellite training and operating the MLM, such as satellite 111. Alternatively, or in addition, the training data may be from various satellites that may have operated within a same area. In one example, MLM training may be performed offline, e.g., in a network-based server associated with terrestrial cellular RAN 101 and deployed/provided to one or more satellites for use. In various examples, the metrics of success may be over a period of time.

It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In one example, MLMs of the present disclosure may include an ML-based generative model, such as a language model, e.g., a “large language model” (LLM). For instance, a ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In one example, the present disclosure may fine-tune a base language model or may custom-build a language model to provide high-level instructions for radio access network (RAN), cellular network, and/or satellite network-specific issues. In addition, in one example, the present disclosure may further enhance such a fine-tuned MLM to provide concrete, actionable instructions, e.g., parameter selections for uplink and/or downlink satellite-based direct to cellular communications. For instance, a generative language model of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store, as well as current information for one or more input factors such as described above. In one example, input data for such a LLM-based generative model may include converting categorical or numerical data to text form, as well as vectorization of textual data to vectors (e.g., via word2vec, doc2vec, Global Vectors for Word Embedding (GloVe), or the like, using n-grams, and so forth). In one example, tailored prompts may be used in connection with a generative MLM of the present disclosure, e.g., to obtain outputs that may comprise instructions in useable format with respect to other network functions, such as outputs formatted for 3GPP/5G standards compliant communications, IEEE 802.11 standards compliant communications, or the like. For instance, the prompt may explicitly request a selection of values for the tunable parameters, e.g., where the prompt may list the acceptable range of values for each parameter (e.g., a maximum and minimum interval duration, etc.) and/or where further information about the satellites, the tunable parameters, and such may be obtained for appending as RAG content.

In one example, the endpoint device, such as endpoint device 163 may have direct awareness of its own status information (e.g., by maintaining records of such metric(s)), such as data demand, movement, location, battery condition, etc. In addition, satellites 111-113 may share status information with each other via ISLs 175-177. In one example, a satellite, such as satellite 111, may continue to gather performance data to determine whether parameter value selections are “successful”/”unsuccessful” or the like, e.g., where satellite 111 and/or a network-based server may use the performance data as labels for MLM training/retraining (e.g., automated machine learning (autoML)).

It should be noted that FIG. 1 illustrates (and the foregoing describes) just several examples in accordance with the present disclosure. Thus, it should be appreciated that other, further, and different examples may readily be devised in accordance with the present disclosure. As just one example, the system 100 may alternatively or additionally include NTN nodes of varying types, such as balloons, UAVs, etc. It should be noted that in some examples, the satellite network (e.g., satellites 111-113 and ground stations 131-133) may be controlled and/or operated by one or more entities that are different from the terrestrial cellular RAN and/or a cellular core network associated therewith. As such, in different examples, satellite access components (e.g., satellites 111-113 and ground stations 131-133) may be designated as trusted or untrusted, such that data ingress and egress to the cellular core network may be via shared gateway, a security gateway (SeGW), and/or a non-3GPP inter-working function (N3IWF) (e.g., a non-cellular network interworking function). In particular, a N3IWF enables protocol data unit (PDU) session establishment via a UPF for endpoint devices connecting to external networks beyond the cellular core via trusted and untrusted non-cellular (e.g., non-3GPP) access networks. These can include IEEE 802.11/Wi-Fi networks, and in accordance with the present disclosure, may further include satellite access networks. In this regard, it should also be noted that the terrestrial cellular RAN 101 may also interface with one or more cellular core networks, some or all of which may be operated by a different entity other than the terrestrial cellular RAN 101. For example, the terrestrial cellular RAN 101 may comprise a private cellular network or a RAN of a peer cellular network. For instance, in one example, terrestrial cellular RAN 101 may be made available by a host mobile network operator (MNO) that provides for shared use of terrestrial cellular RAN 101 by one or more other MNOs, e.g., those operating one or more cellular core networks. In one example, aspects described above in connection with one or more of the satellites 111-113 may alternatively or additionally be performed by another component of the system 100 such as one of the ground stations 131-133, one of the terrestrial baseband units 141-143, or the like. For instance, one more such terrestrial systems may perform all or a portion of the bandwidth/power management for one or more of the satellites 111-113 as described herein.

In addition, the foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For instance, intermediate devices and links between cell sites 151-154 or BBUs 141-143 and other components of system 100 are omitted for clarity, such as additional routers, switches, gateways, and the like. Likewise, links to one or more cellular core networks are also omitted for ease of illustration. Thus, these and other modifications are all contemplated within the scope of the present disclosure.

FIG. 3 illustrates a flowchart of an example method 300 for selecting for a communication satellite at least a first communication interval frequency and at least a first communication duration within the at least the first communication interval based upon a battery level indicator and at least one sunlight timing factor, in accordance with the present disclosure. In one example, steps, functions and/or operations of the method 300 may be performed by a device as illustrated in FIG. 1, e.g., one of the satellites 111-113, or collectively via a plurality of devices in FIG. 1, such as one of the satellites 111-113 in conjunction with one or more BBUs 141-143, ground stations 131-133 and so forth. In one example, the steps, functions, or operations of method 300 may be performed by a computing device or system 400, and/or a processing system 402 as described in connection with FIG. 4 below. For instance, the computing device or system 400 may represent at least a portion of a device or system, such as one of the satellites 111-113, configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system, such as processing system 402. The method 300 begins in step 305 and proceeds to step 310.

At step 310, the processing system (e.g., of a communication satellite) obtains a battery level indication of a battery level of the communication satellite. For instance, the communication satellite may include one or more rechargeable batteries, e.g., a battery array. In addition, the battery, or batteries, may include monitoring circuitry to report the current charge level and/or charge/capacity remaining.

At step 320, the processing system determines at least one sunlight timing factor associated with an exposure of the communication satellite to sunlight. For instance, in one example, the at least one sunlight timing factor may include a first duration of time until the communication satellite will be exposed to the sunlight. In addition, in one example, the at least one sunlight timing factor may further include a second duration of time that the communication satellite will be exposed to the sunlight following the first duration of time. In another example, the at least one sunlight timing factor may include a duration of time remaining until the communication satellite will be blocked from the sunlight.

At optional step 330, the processing system may determine at least one orientation factor indicating an orientation of at least one component of the communication satellite. For instance, the at least one orientation factor may be an indication of an orientation, e.g., an angle, of at least one solar panel of the communication satellite (e.g., with respect to reference point, such as the Sun, or a center of the Sun, a point on the Earth directly below the communication satellite, a plane intersecting the satellite that is parallel to a tangent plane at the point on the Earth directly below the communication satellite, or the like).

At optional step 340, the processing system may calculate a quality of service factor associated with one or more endpoint devices served by the communication satellite. For instance, as discussed above the quality of service factor may be based on an average quality of service (e.g., as demanded/needed by endpoint devices and/or services used by such endpoint devices) and a number of the one or more endpoint devices, or the like.

At optional step 350, the processing system determines an availability of at least one other communication satellite for an inter-satellite link. For instance, this factor may be relevant to the possibility of indirect backhaul and/or for offloading of endpoint devices to such other satellite(s). For example, these options may enable the communication satellite to more aggressively permit consumption of its own battery, where the risk of a depletion of the battery too quickly may be counterbalanced by the option to offload.

At step 360, the processing system selects at least a first communication interval frequency and at least a first communication duration within at least a first communication interval based upon the battery level indicator and the at least one sunlight timing factor. For instance, as discussed above, the first communication interval frequency may be a duration of time between communication intervals (e.g., between the first communication interval and a second communication interval). In one example, the selecting of the at least the first communication interval frequency and the at least the first communication duration may be further based on the at least one orientation factor that may be determined at optional step 330. Similarly, in one example, the selecting of the at least the first communication interval frequency and the at least the first communication duration may be further based upon the quality of service factor that may be calculated at optional step 340. Alternatively, or in addition, the selecting of the at least the first communication interval frequency and the at least the first communication duration may be further based upon the availability of the at least one other communication satellite for the inter-satellite link that may be determined at optional step 350. It should be noted that the selecting may be based on any one or more additional factors such as discussed above, such as a weather factor, and so forth.

In one example, the selecting of the at least the first communication interval frequency and the at least the first communication duration within the at least a first communication interval may be via a machine learning model (MLM) implemented by the processing system. For instance, the MLM may be trained to generate the at least the first communication interval frequency and the at least the first communication duration within the at least a first communication interval in response to an input vector comprising: the battery level indication of the battery level of the communication satellite and the at least one sunlight timing factor. In one example, the input vector may further include other factors such as discussed above (e.g., an orientation factor, an ISL availability factor, a weather factor, etc.). In various examples, the MLM may include a deep neural network (DNN), a gradient boosted decision tree (GBDT), a language model (e.g., a large language model (LLM)), or the like. To further illustrate, in one example, step 360 may include applying, to the MLM, an input vector comprising: the battery level indication of the battery level of the communication satellite and the at least one sunlight timing factor (and in some examples one or more additional factors), and generating, via the MLM in accordance with the input vector, the at least the first communication interval frequency and the at least the first communication duration within the at least a first communication interval.

At step 370, the processing system processes first data via the communication satellite in accordance with the at least the first communication interval frequency and the at least the first communication duration within the at least the first communication interval. In one example, the processing of the first data at step 370 may be via the inter-satellite link (the availability of which may be determined at optional step 350). The processing may include transmitting and/or receiving the first data (e.g., to or from one or more endpoint devices). In one example, the first communication interval frequency and the first communication duration may be for communications between the communication satellite and ground station. Following step 370, the method 300 proceeds to step 395 where the method 300 ends.

It should be noted that the method 300 may be expanded to include additional steps or may be modified to include additional operations with respect to the steps outlined above. For example, the method 300 may be repeated on an ongoing basis to perform steps 310-370. In one example, the method 300 may be expanded to include training the MLM that may be implemented at step 360. In such example, the method 300 may further include collecting labels/feedback from endpoint devices and/or performance data from network components for sample labeling and for MLM training/retraining, and so forth. In one example, the sunlight timing factor may be modified by another factor associated with solar panel ageing (e.g., a reduction in forecast ability to recharge the one or more batteries based upon the age of the solar panel(s). In one example, the method 300 may be expanded or modified to include steps, functions, and/or operations, or other features described in connection with the example(s) of FIG. 1 and 2, or as described elsewhere herein. Thus, these and other modifications are all contemplated within the scope of the present disclosure.

In addition, although not specifically specified, one or more steps, functions, or operations of the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. For example, any one or more components or devices illustrated in FIG. 1 or described in connection with the example method 400 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for selecting for a communication satellite at least a first communication interval frequency and at least a first communication duration within the at least the first communication interval based upon a battery level indicator and at least one sunlight timing factor, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 406 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for selecting for a communication satellite at least a first communication interval frequency and at least a first communication duration within the at least the first communication interval based upon a battery level indicator and at least one sunlight timing factor (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for selecting for a communication satellite at least a first communication interval frequency and at least a first communication duration within the at least the first communication interval based upon a battery level indicator and at least one sunlight timing factor (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor of a communication satellite, a battery level indication of a battery level of the communication satellite;
determining, by the processing system, at least one sunlight timing factor associated with an exposure of the communication satellite to sunlight;
selecting, by the processing system, at least a first communication interval frequency and at least a first communication duration within at least a first communication interval based upon the battery level and the at least one sunlight timing factor; and
processing, by the processing system, first data via the communication satellite in accordance with the at least the first communication interval frequency and the at least the first communication duration within the at least the first communication interval.

2. The method of claim 1, wherein the at least one sunlight timing factor comprises a first duration of time until the communication satellite will be exposed to the sunlight.

3. The method of claim 2, wherein the at least one sunlight timing factor further comprises a second duration of time that the communication satellite will be exposed to the sunlight following the first duration of time.

4. The method of claim 1, wherein the at least one sunlight timing factor comprises a duration of time remaining until the communication satellite will be blocked from the sunlight.

5. The method of claim 1, further comprising:
determining at least one orientation factor indicating an orientation of at least one component of the communication satellite.

6. The method of claim 5, wherein the at least one orientation factor comprises an indication of an orientation of at least one solar panel of the communication satellite.

7. The method of claim 5, wherein the selecting of the at least the first communication interval frequency and the at least the first communication duration is further based on the at least one orientation factor.

8. The method of claim 1, wherein the first communication interval frequency comprises a duration of time between communication intervals.

9. The method of claim 1, further comprising:
calculating a quality of service factor associated with one or more endpoint devices served by the communication satellite.

10. The method of claim 9, wherein the selecting of the at least the first communication interval frequency and the at least the first communication duration is further based upon the quality of service factor.

11. The method of claim 9, wherein the quality of service factor is based on an average quality of service and a number of the one or more endpoint devices.

12. The method of claim 1, further comprising:
determining an availability of at least one other communication satellite for an inter-satellite link.

13. The method of claim 12, wherein the selecting of the at least the first communication interval frequency and the at least the first communication duration is further based upon the availability of the at least one other communication satellite for the inter-satellite link.

14. The method of claim 12 wherein the processing first data via the communication satellite in accordance with the at least the first communication interval frequency and the at least the first communication duration within the at least the first communication interval comprises processing the first data via the inter-satellite link.

15. The method of claim 1, wherein the selecting of the at least the first communication interval frequency and the at least the first communication duration within the at least a first communication interval is via a machine learning model implemented by the processing system.

16. The method of claim 15, wherein the machine learning model is trained to generate the at least the first communication interval frequency and the at least the first communication duration within the at least a first communication interval in response to an input vector comprising: the battery level indication of the battery level of the communication satellite and the at least one sunlight timing factor.

17. The method of claim 15, wherein the selecting comprises:
applying, to the machine learning model, an input vector comprising: the battery level indication of the battery level of the communication satellite and the at least one sunlight timing factor; and
generating, via the machine learning model in accordance with the input vector, the at least the first communication interval frequency and the at least the first communication duration within the at least a first communication interval.

18. The method of claim 15, wherein the machine learning model comprises a reinforcement learning model.

19. A non-transitory computer-readable medium storing instructions which, when executed by a processing system including at least one processor of a communication satellite, cause the processing system to perform operations, the operations comprising:
obtaining a battery level indication of a battery level of the communication satellite;
determining at least one sunlight timing factor associated with an exposure of the communication satellite to sunlight;
selecting at least a first communication interval frequency and at least a first communication duration within at least a first communication interval based upon the battery level and the at least one sunlight timing factor; and
processing first data via the communication satellite in accordance with the at least the first communication interval frequency and the at least the first communication duration within the at least the first communication interval.

20. A communication satellite comprising:
a processing system including at least one processor; and
a non-transitory computer-readable medium storing instructions which, when executed by the processing system, cause the processing system to perform operations, the operations comprising:
obtaining a battery level indication of a battery level of the communication satellite;
determining at least one sunlight timing factor associated with an exposure of the communication satellite to sunlight;
selecting at least a first communication interval frequency and at least a first communication duration within at least a first communication interval based upon the battery level and the at least one sunlight timing factor; and
processing first data via the communication satellite in accordance with the at least the first communication interval frequency and the at least the first communication duration within the at least the first communication interval.
